(19) United States
(12) Patent Application Publication
(10) Pub. No.: US 2024/0037769 A1
(43) Pub. Date: Feb. 1, 2024

(54) Body Measurement Prediction from Depth Images and Associated Methods and Systems

(71) Applicants: Bryan Hobson Atwood, Berkeley, CA (US); Chong Jin Koh, Las Vegas, NV (US); Kyohei Kamiyama, Tokyo (JP)

(72) Inventors: Bryan Hobson Atwood, Berkeley, CA (US); Chong Jin Koh, Las Vegas, NV (US); Kyohei Kamiyama, Tokyo (JP)

(73) Assignee: Visualize K.K., Tokyo (JP)

(21) Appl. No.: 18/268,385

(22) PCT Filed: Dec. 22, 2021
(86) PCT No.: PCT/US21/64808

§ 371 Date: Jun. 20, 2023

Related U.S. Application Data
(60) Provisional application No. 63/128,857, filed on Dec. 22, 2020.

(51) Int. Cl. G06T 7/60; G06T 19/20; G06T 7/70

(52) U.S. Cl. CPC G06T 7/60; G06T 19/20; G06T 7/70; G06T 2207/10028; G06T 2219/2004

(57) ABSTRACT

Systems and methods for predicting body part measurements of a user from depth images are disclosed. The method first receives a plurality of depth images of a body part of the user from an image-capturing device. Next, the method generates a plurality of individual point clouds based on the plurality of depth images. Next, the method stitches the plurality of individual point clouds into a stitched point cloud, and determines a measurement location based on the stitched point cloud. Finally, the method projects the measurement location to the stitched point cloud, and generates the body part measurement based on the projected measurement location. To determine the measurement location, one embodiment uses a morphed base 3D model, whereas another embodiment uses a 3D keypoint detection algorithm on the stitched point cloud. The method may be implemented on a mobile computing device with a depth sensor.

### FIELD OF THE INVENTION

The present invention is related to a system for generating measurements from depth images of a user. More specifically, the present invention is related to predicting body part measurements from stitched point clouds generated using depth images taken with an image-capturing device, such as a mobile computing device.

### BACKGROUND OF THE INVENTION

The background of the invention section is provided merely to help understand the context of the invention and its application and uses, and may not be considered prior art.

Accurate determination of body measurements and shape finds many important retail, health, and medical applications. For example, the consumer often finds it difficult to choose the correct size when purchasing clothes online, a factor that increases return rates. Moreover, there are additional issues related to online purchases—few people want to measure their own body using a tape measure, and it is difficult to guarantee the accuracy of measurements done manually.

Furthermore, in addition to online purchasing applications, body measurements, such as waist circumference, may be used as an indirect measurement of body fatness, particularly for central or abdominal obesity (i.e., visceral fat). Waist measurement is therefore useful for many wellness and medical applications. For example, waist circumference is an important component of medical examinations of adults. Recent research suggests that medical practitioners should prioritize waist circumference rather than body-mass-index (BMI) when assessing a patient's risk of heart disease—waist circumference measurements greater than 35 inches for women and 40 inches for men are signs of potential metabolic disease.

With the increasing use of mobile computing devices and convenient user applications, users seek ever greater convenience, accuracy, and speed in their use of computing applications. However, current mobile applications for body measurement do not meet the user's expectations. For example, conventional mobile applications of body measurement do not provide for accurate body measurements, due to loose clothing, and so on, and are regarded as inefficient, cumbersome, and prone to error.

Finally, other existing systems to scan the user in three dimensions require the use of specialized hardware. For example, there are systems that create an estimate of body measurements by simultaneously acquiring images with multiple image-capturing devices, which is cumbersome for consumer use. This technique requires the help of a known and structured light source, using a laser solution, or some combination thereof. Other commercial technologies for body measurement rely on three-dimensional (3D) scanners or multiple digital cameras. All of these techniques require specialized and expensive hardware and equipment, as well as specialized training, that is difficult for consumers to use. All of these approaches also require specialized software installation by the user.

Hence, there is a need for a system that can produce a reliable 3D representation of the user for measuring various body parts and body parameters in the most efficient and simple way, ideally suitable for use with a mobile computing device. It is against this background that various embodiments of the present invention were developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings. The present invention provides a system and methods for determining a user's body part measurements from depth images taken using an image-capturing device, such as a mobile smartphone or other mobile computing device.

According to one illustrative embodiment, a computer-implemented method for generating body part measurements from a plurality of depth images of a user is disclosed, the computer-implemented method executable by a hardware processor, the method including receiving the plurality of depth images of a body part of the user from an image-capturing device, generating a plurality of individual point clouds based on the plurality of depth images, stitching the plurality of individual point clouds into a stitched point cloud, determining a measurement location based on the stitched point cloud, projecting the measurement location to the stitched point cloud, and generating the body part measurement based on the projected measurement location.

In one embodiment, the image-capturing device is a Lidar, a depth sensor, a three-dimensional (3D) scanner, or a range-imaging camera.

In one embodiment, the image-capturing device includes a TRUEDEPTH camera.

In another embodiment, the depth images include Red Green Blue-Depth (RGB-D) images.

In yet another embodiment, the method further includes selecting an individual point cloud of the plurality of individual point clouds, detecting a ground plane with respect to the selected individual point cloud by calculating an angle of the image-capturing device with respect to the ground plane using one or more sensors of the image-capturing device, and realigning the selected individual point cloud to the ground plane based on the calculated angle of the image-capturing device.

In one embodiment, the method further includes detecting a ground plane with respect to the stitched point cloud by calculating an angle of the image-capturing device with respect to the ground plane using one or more sensors of the image-capturing device, and realigning the stitched point cloud to the ground plane based on the calculated angle of the image-capturing device.

In one embodiment, the method further includes receiving a two-dimensional (2D) image of the body part, where the 2D image is a monochrome image or a color image, generating one or more 2D keypoints based on the 2D image, and generating an enhanced body part measurement based on the projected measurement location and the one or more 2D keypoints.

In another embodiment, the 2D image is captured by the image-capturing device, where the image-capturing device is configured to capture a plurality of image pairs including a depth image and a corresponding 2D image of the user's body part when the user rotates.

In yet another embodiment, the method further includes receiving a two-dimensional (2D) image of the body part, where the 2D image is a monochrome image or a color image, and displaying the 2D image of the body part and the generated body-part measurement through a graphical user interface (GUI).

In one embodiment, the method further includes selecting one or more subsets of the plurality of depth images, where each of the plurality of individual point clouds is generated based on one of the selected one or more subsets.

In one embodiment, selecting one or more subsets of the plurality of depth images includes selecting a given subset of the depth images from the plurality of depth images upon detecting at least one of a user's body position, a user's body angle, and a user's face angle in the plurality of depth images.

In another embodiment, the method further includes receiving a two-dimensional (2D) image of the body part, where the 2D image is a monochrome image or a color image, where the 2D image is captured by the image-capturing device, and where the image-capturing device is configured to capture a plurality of image pairs including a depth image and a corresponding 2D image of the user's body part, and selecting one or more subsets of the plurality of image pairs, where each of the plurality of individual point clouds is generated based on one of the selected one or more subsets of image pairs.

In yet another embodiment, selecting one or more subsets of the plurality of image pairs includes selecting a given subset of the image pairs from the plurality of image pairs upon detecting at least one of a user's body position, a user's body angle, and a user's face angle in the plurality of image pairs.

In one embodiment, projecting the measurement location to the stitched point cloud includes determining one or more projection points of the user's body part location on the stitched point cloud, where generating the body part measurement based on the projected measurement location includes measuring at least one of a distance, a circumference, and an angle along the one or more projection points on the stitched point cloud.

In one embodiment, the method further includes selecting a base three-dimensional (3D) model from a database, morphing the base 3D model to match the stitched point cloud to generate a morphed 3D model, and determining the measurement location based on the morphed 3D model.

In another embodiment, determining the measurement location further includes determining one or more three-dimensional (3D) keypoints corresponding to the body part on the stitched point cloud.

In yet another embodiment, the one or more 3D keypoints are determined using an algorithm selected from the group consisting of an image recognition algorithm and a 3D keypoint deep learning network (DLN).

In one embodiment, stitching the plurality of individual point clouds includes using a multiway registration process.

In various embodiments, a computer program product is disclosed. The computer program may be used for predicting a user's body part measurements using depth images, and may include a computer-readable storage medium having program instructions, or program code, embodied therewith, the program instructions executable by a processor to cause the processor to perform the aforementioned steps.

In various embodiments, a system is described, including a memory that stores computer-executable components, and a hardware processor, operably coupled to the memory, and that executes the computer-executable components stored in the memory, where the computer-executable components may include components communicatively coupled with the processor that execute the aforementioned steps.

In other embodiments, the present invention is a non-transitory, computer-readable storage medium storing executable instructions, which when executed by a processor, cause the processor to perform a process for predicting a user's body part measurements using depth images, the instructions causing the processor to perform the aforementioned steps.

In yet another embodiment, the present invention is a computerized server including at least one processor, one memory, and a plurality of computer codes embodied on said memory, said plurality of computer codes which when executed causes said processor to execute a process including the aforementioned steps. Other aspects and embodiments of the present invention include the methods, processes, and algorithms including the steps described herein, and also include the processes and modes of operation of the systems and servers described herein.

Yet other aspects and embodiments of the present invention will become apparent from the detailed description of the invention when read in conjunction with the attached drawings.

### BRIEF DESCRIPTION OF THE DRAWINGS

Embodiments of the present invention described herein are exemplary, and not restrictive. Embodiments will now be described, by way of examples, with reference to the accompanying drawings. In these drawings, each identical or nearly identical component that is illustrated in various figures is represented by a reference number. For purposes of clarity, not every component is labeled in every drawing. The drawings are not necessarily drawn to scale, with emphasis instead being placed on illustrating various aspects of the techniques and devices described herein.

The foregoing and other objects, aspects, and advantages are better understood from the following detailed description of a preferred embodiment of the invention with reference to the drawings, in which:

FIG. 1 illustrates a block diagram of a system for generating measurements of a body part of the user by morphing a 3D base model, according to an embodiment of the present invention.

FIG. 2 illustrates a flow chart diagram of a method for generating body part measurements by detecting a measurement location directly on a stitched point cloud, in accordance with one embodiment of the present invention.

FIG. 3 illustrates a flow chart diagram of a method for generating body part measurements by morphing a 3D base model, in accordance with one embodiment of the present invention.

FIG. 4 illustrates a flow chart diagram of a method for generating a user's body part measurement by detecting 3D keypoints on a stitched point cloud, in accordance with one embodiment of the present invention.

FIG. 5 illustrates a flow chart of other illustrative methods for generating body part measurements from selected subsets of received Red Green Blue-Depth (RGB-D) image pairs, in accordance with an exemplary embodiment of the present invention.

FIG. 6 illustrates the morphing of a 3D base model to fit a stitched 3D point cloud, and the localization of a body part (waist), in accordance with an embodiment of this disclosure.

FIG. 7 shows a user's belly waist measurement generated by the system, along with sample imaging and registration parameters, in accordance with an exemplary embodiment of the present invention.

FIG. 8 shows a flow diagram of various illustrative methods for generating a body part measurement from depth images that use a realignment process to align a representation of a user's body part with the ground plane, in accordance with embodiments of the present invention.

FIG. 9 illustrates a system for generating a user's belly waist measurement by individual point cloud stitching, in accordance with an exemplary embodiment of the present invention.

FIG. 10 illustrates a system for generating a user's belly waist measurement by individual point cloud stitching when the image-capturing device is not aligned with the ground plane, in accordance with an exemplary embodiment of the present invention.

FIG. 11 illustrates a system for generating a user's belly waist measurement by individual point cloud stitching using a realignment process, in accordance with an exemplary embodiment of the present invention.

FIG. 12 provides a schematic of a server (management computing entity) used for determining body part measurements from stitched depth images, according to one embodiment of the present invention.

FIG. 13 provides an illustrative schematic representative of a client (user computing entity) that can be used for determining body part measurements from stitched depth images, in conjunction with embodiments of the present invention.

FIG. 14 shows an illustrative architecture diagram of a system used for determining body part measurements from stitched depth images, for implementing one embodiment of the present invention in a client-server environment.

### DETAILED DESCRIPTION OF THE INVENTION

With reference to the figures provided, embodiments of the present invention are now described in detail.

In the following description, for purposes of explanation, numerous specific details are set forth in order to provide a thorough understanding of the invention. It will be apparent, however, to one skilled in the art that the invention can be practiced without these specific details. In other instances, structures, devices, activities, and methods are shown using schematics, use cases, and/or flow diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

The present invention provides a system and method for determining a user's body part measurements from depth images taken, for example, using an image-capturing device. Some embodiments use advanced computer vision combined with machine learning techniques to generate accurate body part measurements of the user. Some embodiments of the present invention leverage the AR (augmented reality) SDK (software development kit) provided in image-capturing devices.

A depth image is an image where the values of individual pixels in the image represent depth measurements. Some embodiments of the present invention combine the use of depth images with conventional two-dimensional (2D) images where individual pixels represent a value other than depth (e.g., intensity or color). The use of any non-depth image format, such as binary, monochrome, greyscale, dichrome, and multichannel color images (e.g., red green blue (RGB) images) to enhance a user's body part measurement falls within scope of the present invention. Such non-depth image formats are collectively referred to as “two-dimensional (2D) images” herein. In one embodiment, one or more RGB images alongside one or more depth images are used to predict a user's body part measurement. In another embodiment, one or more image pairs, each consisting of an RGB image and a corresponding depth image, are used to predict a user's body part measurement. The use of red green blue depth (RGB-D) images hence also fall within the scope of the present invention. The prediction and enhancement of body part measurements using RGB-D images and 2D images is discussed in detail below.

### System Components & 3D Base Model Morphing Embodiment

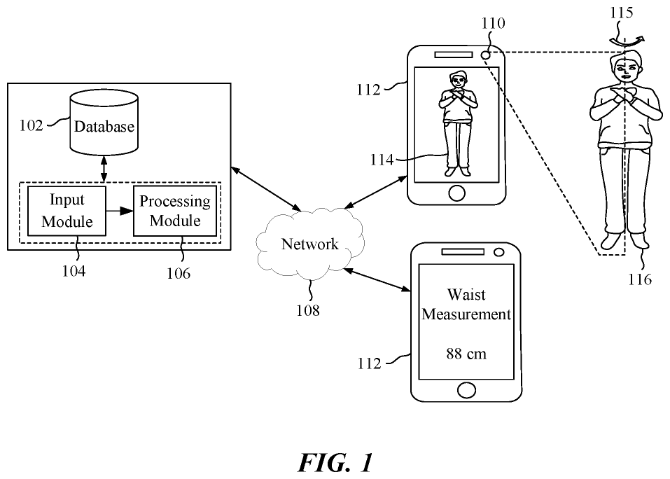

With reference to FIG. 1, the block diagram of a system for generating a body part measurement of a user (116) is shown, according to an embodiment of the present invention. The system includes an image-capturing device (112), a server, and a network (108), where the server includes an input module (104), a processing module (106), and a database (102). The database (102) may have a plurality of base 3D models corresponding to one or more sample human bodies or body parts.

The image-capturing device (112) includes a depth camera (110) which captures a plurality of the depth images (114) of the user (116) when the user (116) rotates. FIG. 1 shows an exemplary rotation of the user (115) around a vertical axis. In another embodiment, the image-capturing device rotates while the user body remains fixed. The image-capturing device may be a smartphone, a camera, a tablet, a laptop, a desktop, or a scanner. Other image-capturing devices fall within the scope of the current invention. Further, the image-capturing device (112) is configured to transmit depth images (114) of the user (116) to the input module (104) of the server through a network (108). The network (108) may have wired or wireless communication links. For example, shortwave, microwave, high-frequency, wireless fidelity (Wi-Fi), Bluetooth, global system for mobile communications (GSM), code division multiple access (CDMA), second-generation (2G), third-generation (3G), fourth-generation (4G), 4G long term evolution (LTE), LTE Advanced, or any other wireless communication technology or standard may be used to establish a wireless communication for exchanging data. The input module (104) of the server is coupled to the processing module (106). The input module (104) and the processing module (106) are further coupled to the database (102). In one embodiment, the processing module (106) is configured to select a subset of the images from the plurality of images of the user's body upon detecting at least one of a user's body position, a user's body angle, and a user's face angle (with respect to the image-capturing device) in the plurality of images. In one embodiment, the processing module (106) is configured to generate individual point clouds for each selected subset of images, generate a 3D point cloud by stitching the individual point clouds, select at least one base 3D model from the database, morph the selected base 3D model(s) to match the 3D point cloud, and determine a user's body part location on the base 3D model. In some embodiments, the 3D point cloud is a complete representation of the user's body. In other embodiments, the 3D point cloud is a partial 3D point cloud that includes one or more body parts of the user.

In one embodiment, the subset of images includes 2D images (e.g., monochrome or color images) of the body part captured by the image-capturing device. In one embodiment, the subset of images includes RGB images of the body part. In another embodiment, the subset of images includes RGB-D image pairs.

In one embodiment, the processing module (106) is configured to project the user's body part location from a morphed base 3D model to the 3D point cloud, determine at least one or more projection points on the user's body part location on the 3D point cloud, generate the user's body part measurement, and transmit the user's body part measurement (e.g., Belly Waist Measurements: 88 cm) to a display of the image-capturing device (112). In some embodiments, measurement generation is based on a measurement of a distance, a circumference, or an angle along the projection points on the 3D point cloud. In one embodiment, the user's body part measurement is generated directly from the body part location determined on the morphed base 3D model. This embodiment is particularly useful when a full 360-degree scan of the body part is not available, hence only a partial stitched point cloud of the body part exists. In some embodiments, a partial stitched point cloud of a user's body or body part is sufficient to generate an accurate body part measurement using the methods described herein.

Accordingly in one exemplary embodiment, the present invention provides a method for generating a user's body part measurements using RGB-D (RGB and depth) images, the method including capturing a plurality of images of a user's body by an image-capturing device, and transmitting the plurality of images of the user's body from the image-capturing device to a server through a wireless network. The server is configured to select a subset of the images from the plurality of images of the user's body, generate individual point clouds for each selected subset of the images, generate a stitched 3D point cloud by stitching the individual point clouds, select at least one base 3D model from a database, morph the selected base 3D model to match the 3D point cloud, determine a user's body part location on the base 3D model, project the user's body part location from the morphed at least one base 3D model to the 3D point cloud, determine one or more projection points on the user's body part location on the 3D point cloud, and generate the user's body part measurement upon measuring at least one of a distance, a circumference, and an angle along the at least one or more projection points on the 3D point cloud.

In another exemplary embodiment, the processing module is configured for utilizing a projection point deep learning module for generating the user's body part measurement from the 3D point cloud.

In other embodiments, instead of measuring the body part with the assistance of the morphed base 3D model, the method includes determining a measurement location directly on the stitched 3D point cloud through image processing, machine learning (ML), or deep learning (DL), and performing the measurement of the body part directly from the stitched 3D point cloud, as described in alternative embodiments below.

Registration of Point Clouds & Direct Measurement from Stitched 3D Point Cloud

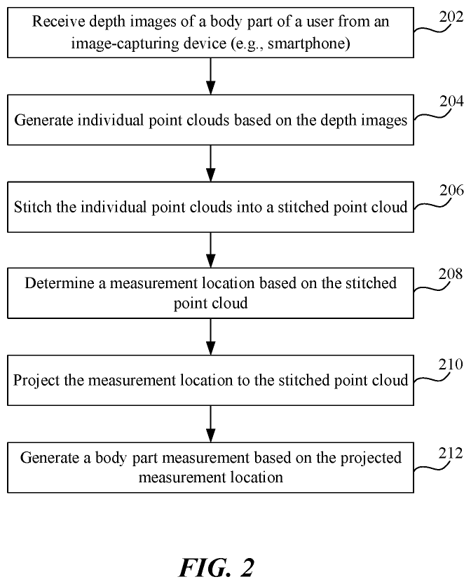

FIG. 2 illustrates a flow chart of a method for determining body part measurements by detecting a measurement location directly on a stitched point cloud, without morphing a base 3D model, in accordance with a preferred embodiment of the present invention. In step (202), the input module obtains a plurality of depth images of a body part from the depth camera or the depth sensor of the image-capturing device (e.g., smartphone). In step (204), the processing module selects and processes the depth images to generates one or more individual point clouds based on the received depth images. The processing module, in step (206), further generates a stitched point cloud from the generated individual point clouds using image registration techniques. In step (208), the processing module determines a measurement location for the body part based on the stitched point cloud. In one embodiment, a projection point deep learning module (DLN) is utilized by the processing module to determine the measurement from the stitched point cloud. The processing module further projects the body part location to the stitched point cloud, in step (210). In step (212), the processing module measures the body part along the projection points. In one embodiment, the processing module further transmits the body part measurement to a display of the image-capturing device.

Image registration and 3D point cloud registration are processes that detect a transformation such as a rotation, a translation, a scaling, or a combination thereof, that is capable of aligning two individual data sets or two individual point clouds. Multiway image registration, or multiway point cloud registration, is the process of aligning multiple images, data sets, or individual point clouds, in a single global space. Registration is usually a multi-step process for aligning overlapping individual data sets or point clouds. The alignment of individual point clouds, each holding a partial representation of a subject or an object (e.g., a body part), enables their merging into a stitched 3D point cloud within a unified coordinate framework. Several algorithms, such as Iterative Closest Point (ICP), can be combined in order to stitch multiple individual point clouds together. The terms “stitched 3D point cloud” and “stitched point cloud” are used interchangeably herein.

### Exemplary 3D Model Morphing Embodiment

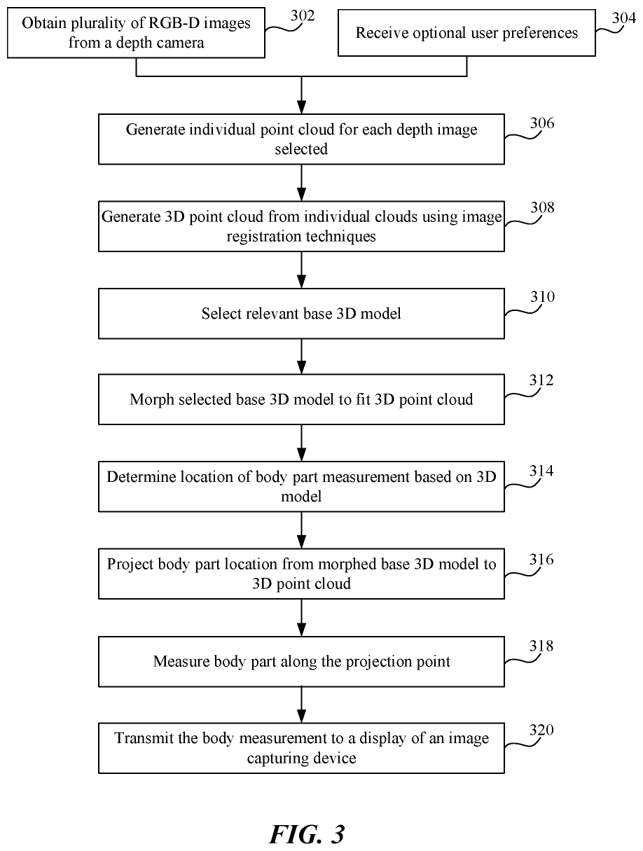

FIG. 3 illustrates a flow chart of a method for generating the body part measurements of a user by morphing a 3D base model, in accordance with an embodiment of the present invention. In step (302), the input module obtains a plurality of red green blue depth (RGB-D) images from the depth camera of the image-capturing device. In step (304), the input module is configured to receive user preferences related to the body part that needs to be measured (e.g., waist, breast, biceps, foot, etc.).

In step (306), the processing module selects and processes the RGB-D images to generate individual point clouds for each RGB-D image selected. The processing module, in step (308), further generates a stitched 3D point cloud from the individual point clouds using image registration techniques. In step (310), the processing module selects a relevant base 3D model and in step (312), the processing module morphs the selected base 3D model to fit the stitched 3D point cloud. In step (314), the processing module determines the location of the body part measurement based on the base 3D model. The processing module further projects the body part location from the morphed base 3D model to the stitched 3D point cloud, as shown in step (316). In step (318), the processing module measures the body part along the projection points and transmits the body part measurement to a display of the image-capturing device in step (320). In one embodiment, a projection point deep learning module is utilized by the processing module to determine the body part measurement from the stitched 3D point cloud.

### Exemplary Direct Measurement Embodiment Using 3D Keypoints

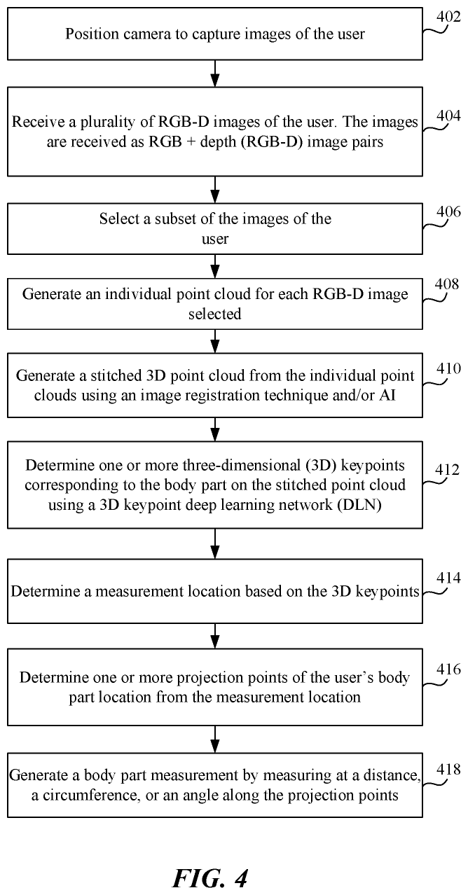

With reference to FIG. 4, a method of generating a user's body part measurement by detecting 3D keypoints on a stitched point cloud is shown, according to one embodiment of this invention. This method directly determines the body part location on a stitched point cloud without using a 3D base model. In step (402), the image-capturing device is positioned for capturing RGB-D images of the user from different angles when the user (i.e., subject) is rotating. A plurality of the RGB-D images are received, as shown in step (404). Further, in step (406), a selection of a subset of the RGB-D images received from the previous step is made for converting into a stitched 3D point cloud. The next step (408) generates an individual point cloud for each RGB-D image selected. In step (410), the individual point clouds are converted to a stitched 3D point cloud by using an image registration technique.

One or more three-dimensional (3D) keypoints corresponding to the body part on the stitched point cloud are then determined using a 3D keypoint deep learning network (DLN), as shown in step (412). Keypoints represent salient features of the targeted body part that may be used to determine a measurement location on a 3D representation of the user's body part, such as a stitched 3D point cloud. The generation of 3D keypoints using a DLN or one or more ML modules is discussed in further detail below.

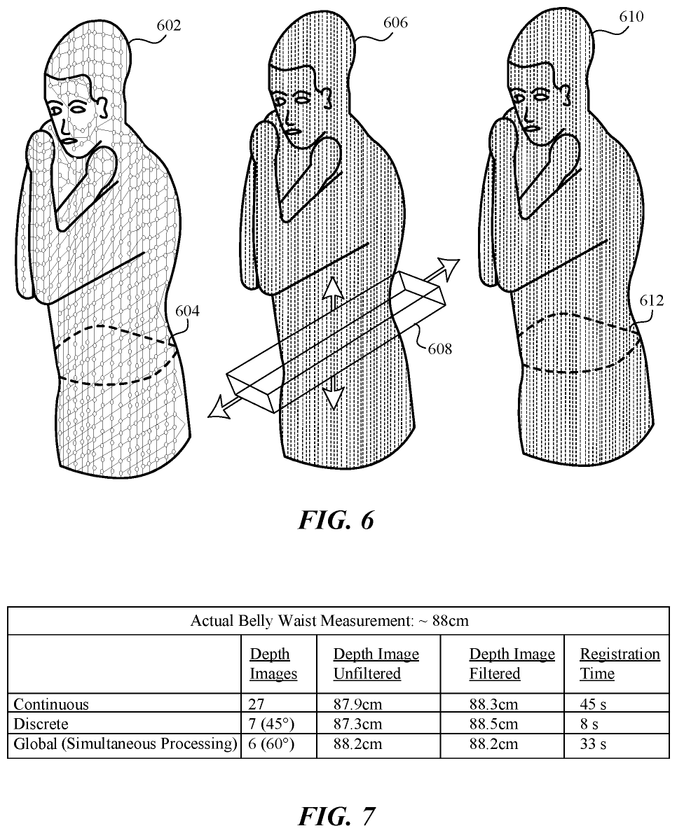

In step (414), a measurement location on the stitched point cloud is determined based on the 3D keypoints. In one embodiment for measuring the waist, the measurement location is a horizontal plane bisecting the belly at a location determined by one or more keypoints such as a detected belly button location (see, for example, FIGS. 6 and 11). The measurement location is then used to determine one or more projection points of the body part location from the measurement location, as seen in step (416). In step 418, a body part measurement is generated by measuring a distance, a circumference, or an angle along the projection points. In the embodiments of FIGS. 6, 9, 10, and 11 discussed below, the horizontal plane projects the measurement location onto the stitched point cloud to generate a body circumference used to measure the waistline.

### Using Selected Subsets of Red Green Blue-Depth (RGB-D) Image Pairs

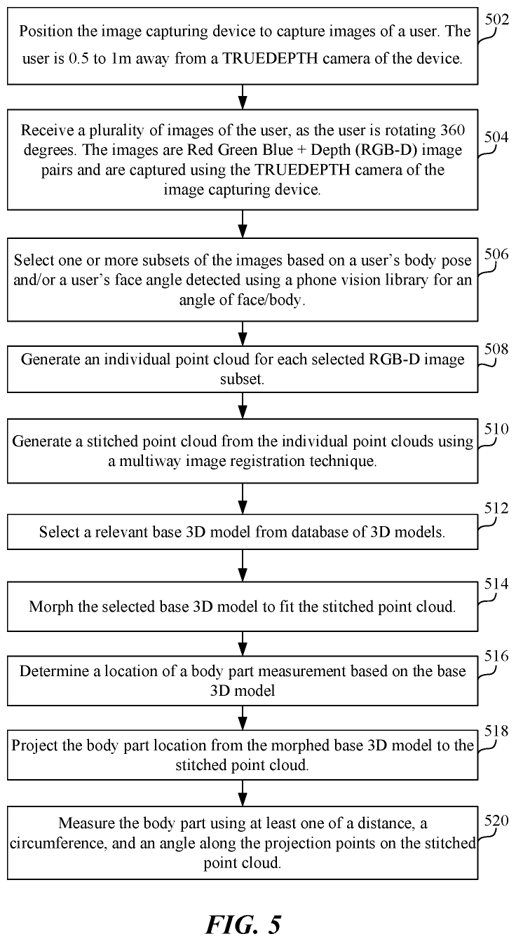

FIG. 5 illustrates a flow chart of other illustrative methods for generating body part measurements from selected subsets of received Red Green Blue-Depth (RGB-D) image pairs, in accordance with an exemplary embodiment of the present invention. Although FIG. 5 shows a method using a morphed 3D base model, other methods that determine a measurement location directly on a stitched point cloud of the body part are compatible with the use of selected subsets of received RGB-D image pairs, as discussed below.

At step (502), an image capturing device (i.e., LIDAR camera, iPad Pro, iPhone 12 Pro) is positioned to capture images of a user. In one example use case, the user leans against an object and the image capturing device is mounted on a tripod, or a person holds the image capturing device. In a second example use case, the user is allowed to self-scan. The user may be instructed to be 0.5 to 1 meters away from a TRUEDEPTH camera of an image capturing device. At step (504), a plurality of Red Green Blue (RGB)+depth (RGB-D) image pairs of the user are received as the user is rotating 360 degrees. The images may be captured using a TRUEDEPTH camera of the image capturing device. In some embodiments, the optimal rotation of the user is 360 degree in 5 seconds. Optionally, the user may be enabled to rotate 180 degrees. At step (506), one or more subsets of the captured images are selected. In some embodiments, the image subset selection is based on a user's body pose and/or a user's body part (e.g., face) angle detected using a phone vision library for an angle of the face/body, where the angle/position of the user's body parts are used to determine the distance of the user from the camera.

At step (508), individual point clouds are generated for each selected RGB-D image subset. In one embodiment, this is carried out by mapping the 2D image plane to a 3D model using a standard pin-hole camera model, and projecting the 3D model into an individual 3D point cloud using a mobile phone image analysis library such as Open 3D, PCL, or OpenCV. In one embodiment, the images in each RGB-D subset are stitched using an image registration process to generate the individual point clouds. At step (510), a stitched point cloud is generated from the individual clouds using a multiway image registration technique. At step (512), a relevant base 3D model is selected from a database of 3D models. In one example use case, the base 3D model is modified by changing mesh densities around measurement targets. At step (514), the selected base 3D model is morphed to fit the stitched point cloud. At step (516), a location of a body part measurement is determined based on the base 3D model.

At step (518), a body part location is projected from the morphed base 3D model to the stitched point cloud. At step (520), a user's body part is measured using a distance, a circumference, or an angle along the projection points on the stitched point cloud. In one embodiment, in case the stitched point cloud is partial (e.g., a 180 degrees rotation was used), measuring can be carried out from the morphed 3D model. Finally, the body part measurements are output to the user.

In one exemplary embodiment, a system for generating a user's body part measurement directly from the stitched point cloud using machine learning, instead of from a 3D mesh (e.g., morphed base 3D model), is disclosed. The user's body part measurement can include waist size, breast size, chest size, bicep size, foot size, etc. The input module of the system is configured to receive the plurality of depth images from the image-capturing device. The processing module is configured to select a subset of depth images from the plurality of received depth images, generate individual point clouds corresponding to each selected depth image, and generate a stitched 3D point cloud by stitching the individual point clouds. Further, the processing module may be configured to apply one or more image processing steps. In some embodiments, the image processing steps can include machine learning (ML) or deep learning (DL). For example, the processing module may be configured to utilize a 3D keypoint deep learning module to determine at least one or more 3D keypoints on the stitched 3D point cloud, where the 3D keypoint deep learning module has been trained on 3D keypoint training data, and where the 3D keypoint training data includes sample point clouds for a set of sample users and a corresponding set of 3D keypoints on the body part (e.g., waist, breast) location for the set of sample users. Further, the processing module may be configured to generate a user's body part measurement upon measuring a distance, a circumference, or an angle along the determined 3D keypoints on the stitched 3D point cloud, and transmit the user's body part measurement to a display of the image-capturing device.

In some embodiments, the 3D keypoints may be determined using an image recognition algorithm, as discussed below.

### Illustrative Example of Waist Measurement

FIG. 6 illustrates the morphing of a 3D base model to fit the stitched 3D point cloud, and the localization of a body part (i.e., waist), in accordance with an embodiment of this disclosure. FIG. 6 shows the morphed 3D base model (602) of a partial body including the waist, where the body part location is clearly delineated by a dashed line 604 marking the measurement location (i.e., waistline). The morphing is carried out to align the 3D base model (602) with the stitched 3D point cloud (606) to locate the user's body part (i.e., waist) location (604) on the stitched 3D point cloud (606). After the morphing process, the waist location identified on the 3D base model is projected on the stitched 3D point cloud. FIG. 6 shows a projection plane (608) that can be shifted in order to identify the waistline on the stitched 3D point cloud (606). The projection plane (608) acts as a body part localization tool to ensure that the waist location is identical on the base 3D model and the stitched 3D point cloud. Hence, one or more projection points (612) identified on the waist location of the 3D base model (602) are projected onto the stitched 3D point cloud (610) after morphing. FIG. 6 illustrates the stitched 3D point cloud 610 showing the projected body part measurement location 612. The user's waist size is then measured by measuring a distance, a circumference, or an angle along the projection points (612) on the stitched 3D point cloud (610).

FIG. 7 shows a user's belly waist measurement generated by the system, along with sample imaging and registration parameters, in accordance with an exemplary embodiment of the present invention. The three rows show three different registration, depth image, image capturing device angle, and image filtering configurations. The user's actual belly waist measurement is around 88 cm. FIG. 7 shows that the system is capable of making an accurate body part measurement.

### Alternative Illustrative Embodiments

In another embodiment of the present invention, the image-capturing device captures red green blue depth (RGB-D) images of the user when the user rotates at 90, 180, or 360 degrees. The RGB-D images are high-resolution images combining an RGB image and its corresponding depth image. In one example, the image-capturing device rotates about 360 degrees to scan and capture a plurality of images of at least one partial body part (for example, biceps, foot, etc.). In another embodiment, the images are captured at regular angular intervals (e.g., at each 45-degree interval) along a full 360-degree rotation around the body or the body part. In yet another embodiment, the images are captured at irregular angular intervals along a partial rotation (e.g., 180 degrees) around the body or the body part.

In yet another embodiment of the present invention, the registration technique for stitching the individual point clouds to generate the stitched 3D point cloud is a multiway registration technique. The multiway registration technique is less sensitive to noise, hence reducing errors and optimizing measurement accuracy.

In yet another embodiment of the present invention, the selected RGB-D Images are converted to individual 3D point clouds by using a standard pinhole camera model. The 2D image model is projected into a 3D point cloud using a software library such as Open 3D, PCL (Point Cloud Library), or Open CV (Open Source Computer Vision Library). These software libraries and programming interfaces offer programming functions mainly aimed at real-time computer vision.

In yet another embodiment of the present invention, the selection of the subset of the depth images is based on the body position of the user in the images (with respect to the image-capturing device). The vision library of an electronic device (e.g., phone, laptop, or PDA) is used for the detection of the angle of face/body and the position of the body parts to determine how far the user is rotating. In one exemplary implementation, the optimal rotation occurs as a 360 degrees rotation in 5 seconds. In another exemplary implementation, the body of the user is rotated 180 degrees.

In one exemplary embodiment, a partial stitched 3D point cloud is generated and a base 3D model of the user or of the body part is used to determine the measurement location on the stitched point cloud as follows. The image-capturing device is configured to capture a plurality of images of a user's body when a user rotates 180 degrees, where the processing module is configured to select a subset of the images from the plurality of images of the user's body, generate individual point clouds for each selected subset of the images, generate a partial stitched 3D point cloud by stitching the individual point clouds, select at least one base 3D model from the database, morph the selected base 3D model to fit the partial stitched 3D point cloud, determine a user's body part location on the base 3D model, project the user's body part location from the morphed base 3D model to the partial stitched 3D point cloud, determine at least one projection point on the user's body part location from the morphed base 3D model to the partial 3D point cloud, and generate the user's body part measurement upon measuring a distance, a circumference, or an angle along the projection point(s) from the morphed base 3D model to the partial stitched 3D point cloud.

In yet another embodiment of the present invention, the processing module determining the body part measurements of the user takes measurements from the stitched 3D point cloud, as it is most accurate. In case the point cloud is partial, (i.e., a 180-degree scan of the body part was performed), the measurements can be taken from the morphed base 3D model. In another embodiment, the system is configured to utilize a projection point deep learning module for generating the user's body part measurement from the stitched 3D point cloud, where the projection point deep learning module has been trained on the 3D point clouds of thousands of sample humans and the corresponding sample body part projection points.

As used hereinafter, the term ‘point cloud’ also refers to a ‘3D point cloud’. The point cloud is digitized data that visually defines an object in 3D space. As depicted in the point cloud, each point is represented by a surface coordinate of the object, similar to a topographical map. The coordinate of each point has a geographical location as well as an attribute. The attribute can be color, intensity, texture, and the like. In contrast, a 3D mesh (e.g., morphed base 3D model) illustrates the structure of an object that is built out of polygons. For example, a 3D mesh is a collection of vertices, edges, and faces that define the shape of an object.

In another exemplary embodiment, a system for generating a user's body part measurement directly from the stitched point cloud using machine learning, instead of from a morphed base 3D model, is disclosed. The user's body part measurement can include waist size, breast size, chest size, bicep size, foot size, etc. The input module of the system is configured to receive the plurality of depth images from the image-capturing device. The processing module is configured to select a subset of depth images, generate individual point clouds corresponding to each selected depth image, and generate a stitched 3D point cloud by stitching the individual point clouds. Further, the processing module is configured to apply one or more image processing steps. In some embodiments, the image processing steps can include machine learning (ML) or deep learning (DL). For example, the processing module may utilize a 3D keypoint deep learning module to determine one or more 3D keypoints on the stitched 3D point cloud, where the 3D keypoint deep learning module was trained on 3D keypoint training data. The 3D keypoint training data may include sample point clouds for a plurality of sample users and corresponding body part (e.g., waist, breast) 3D keypoints indicating the body part location in the sample point clouds. Further, the processing module may be configured to generate the user's body part measurement upon measuring at least one of a distance, a circumference, and an angle along the determined 3D keypoints on the stitched 3D point cloud, and transmit the user's body part measurement to a display of the image-capturing device. In some embodiments, the 3D keypoints may be determined using an image recognition algorithm, as discussed below.

Realignment Process to Align Body Part Representation with the Ground Plane

In some embodiment of the present invention, the generated individual point clouds or the stitched point cloud are aligned with respect to a detected ground plane in order to obtain a more accurate measurement. Alignment with respect to the ground plane is carried out by detecting a ground plane with respect to a selected individual point cloud or the stitched point cloud. The ground plane is detected by calculating the angle between the positional axis or the camera axis of the image-capturing device and the ground plane using a sensor of the image-capturing device. The selected individual point cloud or the stitched point cloud can then be realigned to the ground plane based on the calculated angle of the image-capturing device.

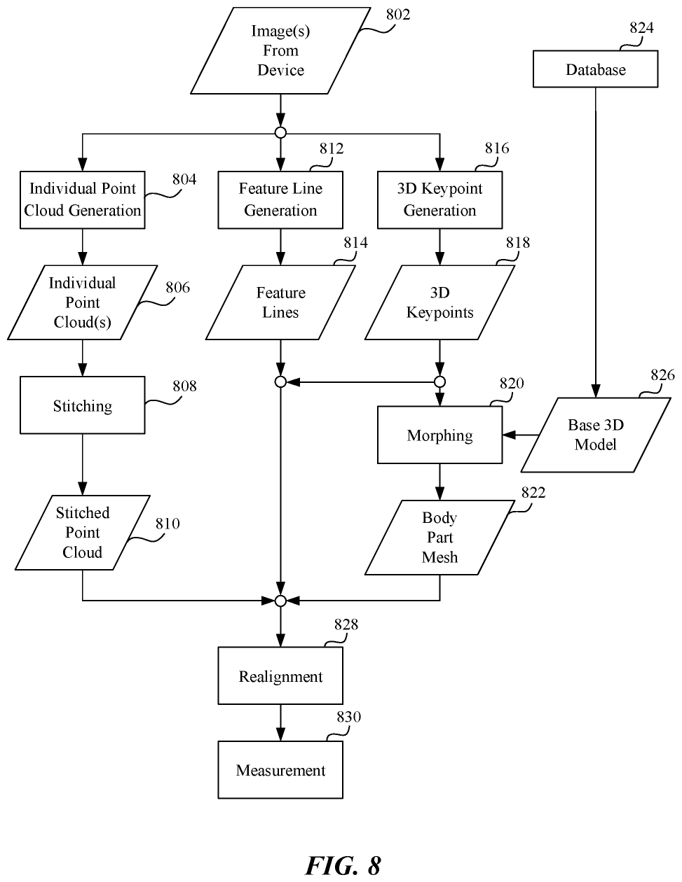

FIG. 8 shows a flow diagram of various illustrative methods for generating a body part measurement from depth images that use a realignment process to align a representation of a body part with the ground plane, in accordance with embodiments of the present invention.

In one embodiment shown in FIG. 8, images (802) received from the image capturing device are used for individual point cloud generation (804). The generated individual point cloud(s) (806) are stitched (808) using a registration process, thus yielding a stitched point cloud (810). A realignment process (828) may be used to align the stitched point cloud (810) to a detected ground plane, as described above. The realigned stitched point cloud is then used for body part measurement (830) through the processes described herein.

In a variant of the embodiment above (not shown in FIG. 8), each individual point cloud (806) is realigned with the ground plane individually before the stitching step (808). As a result, the stitched point cloud (810) is inherently realigned with the ground plane. The realigned stitched point cloud may then either be used directly for body part measurement (830) through the processes described herein, or may undergo a second realignment stage (828) ahead of the measurement (830) step to increase measurement accuracy.

In a second embodiment shown in FIG. 8, the received images (802) are used for the generation (812) of body part feature lines. Realignment (828) of the generated feature lines (814) may then be carried out by detecting a ground plane with respect to the feature lines, calculating an angle of the image-capturing device with respect to the ground plane, and aligning the feature lines to the ground plane based on the calculated angle of the image-capturing device. The realigned feature lines can then be used to determine a body part location for purposes of body part measurement. For example, the feature line end points can be used as indicators of the location of a body part. Alternatively, a machine learning module can be trained and used to generate various body part measurements from body part feature lines.

In a third embodiment shown in FIG. 8, the received images (802) are used for the generation (816) three-dimensional (3D) keypoints of the body part. Realignment (828) of the generated 3D keypoints (818) may then be carried out by detecting a ground plane with respect to the 3D keypoints, calculating an angle of the image-capturing device with respect to the ground plane, and aligning the 3D keypoints to the ground plane based on the calculated angle of the image-capturing device. The realigned 3D keypoints can then be used to determine a body part location for purposes of body part measurement. For example, the 3D keypoints can be used as indicators of the location of a body part. Alternatively, a machine learning module can be trained and used to generate various body part measurements from the 3D keypoints of a body part.

In a fourth embodiment shown in FIG. 8, the generated 3D keypoints (818) are used to morph (820) a base 3D model (826) selected from a database (824) of body part base 3D models to generate a scaled body part mesh (822). Realignment (828) of the body part mesh (822) may then be carried out by detecting a ground plane with respect to the body part mesh, calculating an angle of the image-capturing device with respect to the ground plane, and aligning the body part mesh to the ground plane based on the calculated angle of the image-capturing device. The realigned body part mesh can then be used to determine a body part location for purposes of body part measurement. For example, a machine learning module can be trained and used to generate various body part measurements from the body part mesh.

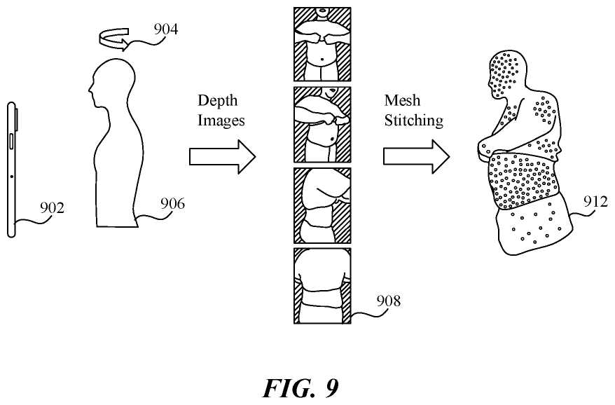

FIG. 8 shows that different body part representations can be used to generate body part measurements, including one or more stitched point clouds (810), feature lines (814), 3D keypoints (818), and body part meshes (822). The generation of one or more body part measurements does not require realignment (828). However, realignment with respect to the ground plane ahead of the measurement step (830) may increase measurement accuracy, as shown in the example of FIGS. 9, 10, and 11.

Note that the measurement step (830) can be implemented using a machine learning module such as a deep learning network (DLN) for each of the body part representations discussed in FIG. 8, where the machine learning module is previously trained using a training data set including sample body part representations (e.g., sample stitched point clouds) and corresponding sample body part measurements for a plurality of sample users.

Furthermore, the generation of each of the body part representations listed in FIG. 8 (i.e., stitching (808), feature line generation (812), 3D keypoint generation (816), and morphing (820)) can be carried out using a distinct and specialized machine learning module.

FIG. 9 illustrates a system for generating a user's belly waist measurement by individual point cloud stitching, in accordance with an exemplary embodiment of the present invention. In FIG. 9, the image-capturing device is a mobile phone (902) that is held vertically facing a user (906). Although the target body part is the waist and the target measurement is the waist girth (i.e., waist circumference), the image-capturing device is configured to capture images of the whole upper body of the user (906). In FIG. 9, depth images are taken of the user's upper body while the user is rotating (904). In one embodiment, the user makes a full 360-degree rotation while the image-capturing device captures depth images at regular time intervals. In another embodiment, the image-capturing device captures depth images at regular angular positions of the user (e.g., every 45 degrees). In yet another embodiment, the image-capturing device is configured to take a continuous stream of depth images. In another embodiment, the user makes a partial rotation (e.g., 180 degrees) while the image-capturing device captures depth images. A subset of depth images (908) is then selected to be converted into individual point clouds, or individual meshes, that are stitched together to generate a stitched point cloud (912). The generated stitched point cloud is formed by combining the individual point clouds using any point cloud registration technique, as discussed above. Although the resulting stitched point cloud may include elements of multiple body parts of the user, it does not necessarily represent the whole body of the user. For example, in FIG. 9, the stitched point cloud (912) includes the surface of the body part targeted for measurement (i.e., the belly waist), as well as partial representation of the lower hips, arms, torso, and head of the user. In the embodiment of FIG. 9, the user is holding their clothing above the waistline to enable the image-capturing device to take depth images of the surface of their belly waist. In other embodiments, the system may be configured to capture images of the user with one or more items of clothing covering the surface of the body part, where the resulting stitched point cloud (912) is generated by a machine learning module trained to generate a stitched point cloud of the body part without clothing from depth images of the body part covered by one or more clothing items.

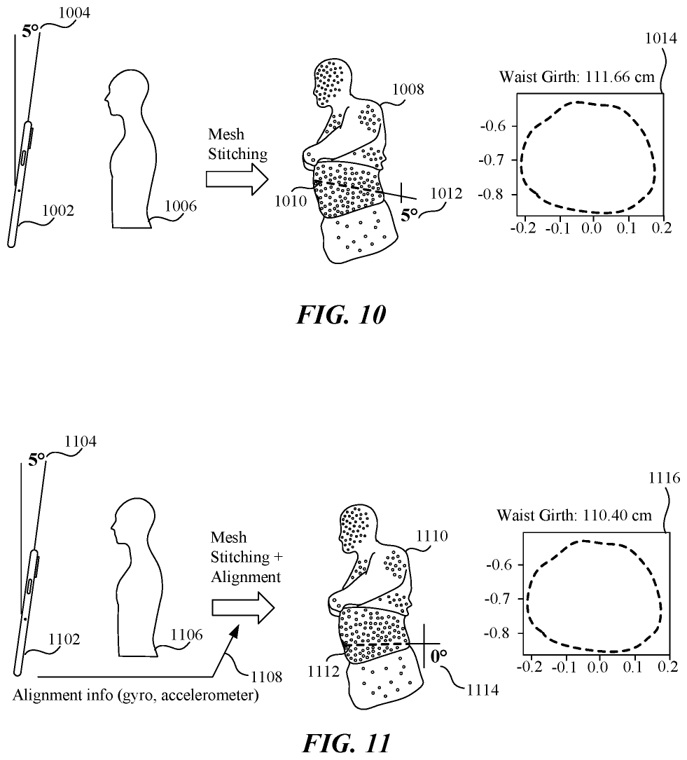

FIG. 10 illustrates a system for generating a user's belly waist measurement by individual point cloud stitching when the image-capturing device is not aligned with the ground plane, in accordance with an exemplary embodiment of the present invention.

FIG. 10 shows the same system as in FIG. 9, except for the angle of the image capturing device. In FIG. 10, the mobile phone (1002) is at a 5-degree angle from the rotational axis of the user's body part (1006). Consequently, the relative angle between the camera and the user (1006), rather than being horizontal (i.e., parallel to the ground plane), is tilted by 5 degrees from the ground plane. FIG. 10 shows the detected waistline position (1010) when the generated stitched point cloud (1008) is not realigned with the ground plane. Due to the 5-degree angle (1004) of the image-capturing device in FIG. 10, the detected waistline (1010) on the stitched point cloud is tilted by 5 degrees from its desirable position parallel the ground plane (1012). The inaccurate body part location (1010) in FIG. 10 leads to an inaccurate waist girth measurement (1014) of 111.66 cm.

FIG. 11 illustrates a system for generating a user's belly waist measurement by individual point cloud stitching using a realignment process, in accordance with an exemplary embodiment of the present invention. FIG. 11 shows the same configuration as FIG. 10, where the image-capturing device (1102) exhibits a 5-degree angle (1104) with the vertical axis. However, in the embodiment of FIG. 11, the image-capturing device (1102) generates alignment information (1108) that enables the realignment of the generated stitched point cloud (1110) with the ground plane.

In one embodiment, the alignment information includes the angle of the image-capturing device (1104). In some embodiments, the alignment information (1108) is detected using a sensor of the image-capturing device such as a gyroscope or an accelerometer. In other embodiments, the sensor of the image-capturing device is a pedometer, a magnetometer, or a barometer. Other embodiments may use other sensors that generate orientation information of the image-capturing device relative to the ground plane. In one embodiment, a software library such as APPLE's Core Motion library may be used to fuse the data from two or more of the image-capturing device's on-board hardware (e.g., sensors) to generate the alignment information (1108). APPLE's Core Motion library documentation lists the different sensors that may be used to generate alignment information, and is described at https://developer.apple.com/documentation/coremotion, which is herein incorporated by reference as if fully set forth herein.

The alignment information (1108) may be used to realign the stitched point cloud (1110) with the ground plane, leading to the desired zero-degree angle (1114) between the detected waistline (1112) and the ground plane. The more accurate body part location (1112) in the configuration of FIG. 11 leads to a more accurate body part measurement (1116). In particular, the horizontal waistline location (1112) of FIG. 11 leads to a more accurate waist girth measurement (1116) of 110.40 cm. The realignment process described in FIG. 11 yields an improvement in waist measurement accuracy that is over 1 cm. Such an improvement in accuracy is significant in multiple applications.

### Enhancing the Measurement Process Using Additional 2D Images

In some embodiments of the present invention, measurement predictions are enhanced using 2D images of the user's body part, where 2D images denote any non-depth image format such as monochrome and color image formats, as discussed above. In various such embodiments, a 2D image is received from the image-capturing device. 2D keypoints of the user's body part are generated based on the 2D image, and an enhanced measurement of the body part is generated based on a combination of the 2D keypoints and the body part location previously detected on the stitched cloud. 2D keypoint generation is discussed in further detail below.

In various embodiments, the 2D keypoints are detected from a received monochrome or color image. A new body part measurement is then generated based on the 2D keypoints. In one embodiment, the new body part measurement is generated using a ML module trained to generate body part measurements from 2D keypoints of a user's body part. Exemplary embodiments of methods to generate body part measurements from 2D images by detecting 2D keypoints using one or more ML modules are described in more detail in U.S. Pat. No. 10,321,728, which is hereby incorporated by reference in its entirety herein as if fully set forth herein.

The body part measurement generated from the stitched point cloud (i.e., the original body part measurement) is then enhanced based on the new body part measurement generated based on the 2D keypoints. In some embodiments, the enhanced body part measurement is a function of the original body part measurement and new body part measurements (e.g., a mean or a median). In one embodiment, the enhanced body part measurement is a weighted average of multiple readings of the original and new body part measurements. In other embodiments, the enhanced body part measurement is generated using a ML module trained to generate an enhanced body part measurement from one or more body part measurements generated using 2D keypoints and one or more body part measurements generated using a stitched point cloud.

In another embodiment, the 2D keypoints generated from a received 2D image (e.g., a monochrome or color image) are used to modify the previously determined measurement location of the body part on the stitched point cloud, to generate an enhanced measurement location. The enhanced body part measurement is therefore generated based on the enhanced measurement location. In yet another embodiment, the 2D keypoints generated from a received 2D image are used to modify the previously generated projected measurement location of the body part on the stitched point cloud, yielding an enhanced projected measurement location. The enhanced body part measurement is therefore generated based on the enhanced projected measurement location. In one embodiment, the 2D keypoints generated from a received 2D image are used to modify one or more projection points of the user's body part location on the stitched point cloud, thus generating one or more enhanced projection points. In one embodiment, one or more enhanced projection points are generated using a ML module trained to generate one or more enhanced projection points from one or more projection points of a user's body part location on a stitched point cloud and one or more 2D keypoints of the body part. The enhanced body part measurement is then generated based on the one or more enhanced projection points. In one embodiment, the enhanced body part measurement is generated by measuring at least one of a distance, a circumference, and an angle along the one or more enhanced projection points on the stitched point cloud.

In yet another embodiment, the 2D keypoints generated from a received 2D image are used to modify the previously generated stitched point cloud, yielding an enhanced stitched point cloud. In one embodiment, the enhanced stitched point cloud is generated using a ML module trained to generate an enhanced stitched point cloud from a stitched point cloud of a user's body part and one or more 2D keypoints of the body part.

In other embodiments, multiple body part measurements of a user's body part are generated and combined to generate an enhanced body part measurement using the methods described above.

### 3D and 2D Keypoint Generation

3D keypoint annotation is the process of annotating a 3D representation of the body part (e.g., a stitched point cloud) by detecting 3D keypoints (i.e., feature points) within the 3D representation (e.g., on the surface of the body part). The annotation of the stitched point mesh may be required as an initial stage in the generation of the body part measurement. Annotation is the generation of annotation 3D keypoints indicating salient features of the target body part. Mesh and point cloud annotations may be carried out through one or more 3D keypoint DLN modules that have been trained on a specific body part.

The keypoint detection process falls under the broad category of landmark detection. Landmark detection is a category of computer vision applications where DLNs are commonly used. Landmark detection denotes the identification of salient features in 2D or 3D imaging data and is widely used for purposes of localization, object recognition, etc. Various DLNs such as PointNet, FeedForward Neural Network (FFNN), Faster Regional Convolutional Neural Network (Faster R-CNN), and various other Convolutional Neural Network (CNNs) were designed for landmark detection. The 3D keypoint DLN can be based on any 3D landmark detection machine learning algorithm, such as a PointNet.

PointNets are highly efficient DLNs that are applied in 3D semantic parsing, part segmentation, as well as classification. PointNets are designed to process point clouds directly, hence allowing effective 3D landmark detection. PointNets also avoid unnecessary transformations of the unstructured 3D mesh input. In one embodiment, the PointNet algorithm is implemented as described in Charles R. Qi, et al., “PointNet: Deep Learning on Point Sets for 3D Classification and Segmentation,” CVPR 2017, Nov. 9, 2017, available at arXiv: 1612.00593, which is hereby incorporated by reference in its entirety herein as if fully set forth herein. PointNets are only illustrative DLN algorithms that are within the scope of the present invention, and the present invention is not limited to the use of PointNets. Other DLN algorithms are also within the scope of the present invention. For example, in one embodiment of the present invention, a convolutional neural network (CNN) is utilized as a 3D keypoint DLN to extract body part 3D keypoints and to annotate stitched point clouds.

To carry out 3D keypoint annotation, the 3D keypoint DLN must be trained beforehand using training data sets including body part stitched point clouds and corresponding 3D keypoint annotations. 3D keypoint annotation DLNs can be trained to detect 3D keypoints for a specific type of body part. The 3D keypoint annotation DLN produces an annotated stitched point cloud, where the 3D keypoints can be used to identify a body part location or to make a body part measurement.

2D keypoint annotation is the process of annotating a 2D representation of the body part (e.g., a 2D image) by detecting 2D keypoints (i.e., feature points) within the 2D representation (e.g., on the surface of the body part). The annotation of a 2D image of a user's body part may be required to enhance a body part measurement. Annotation is the generation of annotation 2D keypoints indicating salient features of the target body part.

2D keypoint generation may be carried out through one or more 2D keypoint DLN modules that have been trained on a specific body part (e.g., human foot). In some embodiments, the segmentation of the object from the background may be carried out by a separate DLN. The 2D keypoint generation process also falls under the category of landmark detection, as discussed above. Various landmark DLNs, such as the Stacked Hourglass Convolutional Neural Network (CNN), HRNet, FeedForward Neural Network (FFNN), Faster Regional Convolutional Neural Network (Faster R-CNN), and other CNNs, may be used to build a 2D keypoint DLN.

To carry out 2D keypoint annotation, the 2D keypoint DLN must be trained beforehand using training data sets including body part images and corresponding keypoints. 2D keypoint DLNs can be trained to detect keypoints for a specific type of body part. In some embodiments, segmentation (i.e., the separation of the object from its background) and annotation can be carried out through different DLNs, as mentioned above.

In some embodiments, the 3D keypoints or the 2D keypoints may be determined using an image recognition algorithm. Image recognition algorithms include any object detection or pose detection algorithm or ML module (e.g., DLN). Pose detection algorithms return a set of feature points that map to the body or body part and indicate its pose or position. Such feature points typically include joints of the shoulders, elbows, knees, and also facial feature points such as eye, mouth, and ear contour points.

The DLN algorithms listed above for the various DLN applications disclosed herein (e.g., PointNet) are only illustrative algorithms that are within the scope of the present invention, and the present invention is not limited to the use of the listed DLN algorithms. Other DLN algorithms are also within the scope of the present invention. Moreover, other machine learning (ML) methods may be used instead of or in combination with the various listed DLN algorithms. Other ML algorithms including, but not limited to, regressors, nearest neighbor algorithms, decision trees, support vector machines (SVM), Adaboost, Bayesian networks, fuzzy logic models, evolutionary algorithms, and so forth, are hence within the scope of the present invention.

### Exemplary System Architecture

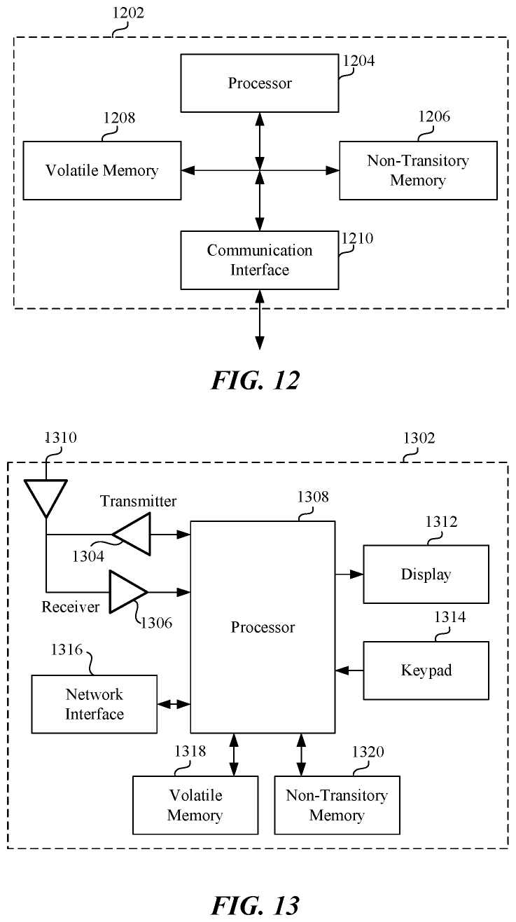

An exemplary embodiment of the present disclosure may include one or more servers (management computing entities), one or more networks, and one or more clients (user computing entities) for implementing various embodiments of the present invention. Each of these components, entities, devices, and systems (similar terms used herein interchangeably) may be in direct or indirect communication with, for example, one another over the same or different wired or wireless networks. Additionally, while FIGS. 12 and 13 illustrate the various system entities as separate, standalone entities, the various embodiments are not limited to this particular architecture.

### Exemplary Management Computing Entity

FIG. 12 provides a schematic of a server (management computing entity, 1202) according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably).

As indicated, in one embodiment, the management computing entity (1202) may also include one or more communications interfaces (1210) for communicating with various computing entities, such as by communicating data, content, and/or information (similar terms used herein interchangeably) that can be transmitted, received, operated on, processed, displayed, stored, and/or the like.

As shown in FIG. 12, in one embodiment, the management computing entity (1202) may include or be in communication with one or more processors (i.e., processing elements, 1204, also referred to as processors and/or processing circuitry, and similar terms used herein interchangeably) that communicate with other elements within the management computing entity (1202) via a bus, for example. As will be understood, the processor (1204) may be embodied in a number of different ways. For example, the processor (1204) may be embodied as one or more complex programmable logic devices (CPLDs), microprocessors, multi-core processors, coprocessing entities, application-specific instruction-set processors (ASIPs), microcontrollers, and/or controllers. Further, the processor (1204) may be embodied as one or more other processing devices or circuitry. The term circuitry may refer to an entire hardware embodiment or a combination of hardware and computer program products. Thus, the processor (1204) may be embodied as integrated circuits, application-specific integrated circuits (ASICs), field-programmable gate arrays (FPGAs), programmable logic arrays (PLAs), hardware accelerators, other circuitry, and/or the like. As will therefore be understood, the processor (1204) may be configured for a particular use or configured to execute instructions stored in volatile or non-volatile (or non-transitory) media or otherwise accessible to the processor (1204). As such, whether configured by hardware or computer program products, or by a combination thereof, the processor (1204) may be capable of performing steps or operations according to embodiments of the present disclosure when configured accordingly.

In one embodiment, the management computing entity (1202) may further include or be in communication with non-transitory memory (also referred to as non-volatile media, non-volatile storage, non-transitory storage, memory, memory storage, and/or memory circuitry—similar terms used herein interchangeably). In one embodiment, the non-transitory memory or storage may include one or more non-transitory memory or storage media (1206), including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile (or non-transitory) storage or memory media may store databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity (1202) may further include or be in communication with volatile media (also referred to as volatile storage, memory, memory storage, memory and/or circuitry—similar terms used herein interchangeably). In one embodiment, the volatile storage or memory may also include one or more volatile storage or memory media 1208, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor (1204). Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity (1202) with the assistance of the processor (1204) and operating system.

As indicated, in one embodiment, the management computing entity (1202) may also include one or more communications interfaces (1210) for communicating with various computing entities, such as by communicating data, content, and/or information (similar terms used herein interchangeably) that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity (1202) may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity (1202) may include or be in communication with one or more input elements, such as a keyboard input, a mouse input, a touch screen/display input, motion input, movement input, audio input, pointing device input, joystick input, keypad input, and/or the like. The management computing entity (1202) may also include or be in communication with one or more output elements (not shown), such as audio output, video output, screen/display output, motion output, movement output, and/or the like.

As will be appreciated, one or more of the components of the management computing entity (1202) may be located remotely from other management computing entity (1202) components, such as in a distributed system. Furthermore, one or more of the components may be combined and additional components performing functions described herein may be included in the management computing entity (1202). Thus, the management computing entity (1202) can be adapted to accommodate a variety of needs and circumstances. As will be recognized, these architectures and descriptions are provided for exemplary purposes only and are not limiting to the various embodiments.

### Exemplary User Computing Entity

A user may be an individual, a company, an organization, an entity, a department within an organization, a representative of an organization and/or person, and/or the like. FIG. 13 provides an illustrative schematic representative of a client (user computing entity, 1302) that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles, watches, glasses, key fobs, radio frequency identification (RFID) tags, earpieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities (1302) can be operated by various parties. As shown in FIG. 13, the user computing entity (1302) can include an antenna (1310), a transmitter (1304) (e.g., radio), a receiver (1306) (e.g., radio), and a processor (i.e., processing element) (1308) (e.g., CPLDs, microprocessors, multi-core processors, coprocessing entities, ASIPs, microcontrollers, and/or controllers) that provides signals to and receives signals from the transmitter (1304) and receiver (1306), respectively.

The signals provided to and received from the transmitter (1304) and the receiver (1306), respectively, may include signaling information in accordance with air interface standards of applicable wireless systems. In this regard, the user computing entity (1302) may be capable of operating with one or more air interface standards, communication protocols, modulation types, and access types. More particularly, the user computing entity (1302) may operate in accordance with any of a number of wireless communication standards and protocols, such as those described above with regard to the management computing entity (1202). In a particular embodiment, the user computing entity (1302) may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity (1302) may operate in accordance with multiple wired communication standards and protocols, such as those described above with regard to the management computing entity (1202) via a network interface (1316).

Via these communication standards and protocols, the user computing entity (1302) can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity (1302) can also download changes, add-ons, and updates, for instance, to its firmware, software (e.g., including executable instructions, applications, program modules), and operating system.

According to one embodiment, the user computing entity (1302) may include location determining aspects, devices, modules, functionalities, and/or similar words used herein interchangeably. For example, the user computing entity (1302) may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's (1302) position in connection with a variety of other systems, including cellular towers, Wi-Fi access points, and/or the like. Similarly, the user computing entity (1302) may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity (1302) may also include a user interface (that can include a display (1312) coupled to a processor (1308) and/or a user input interface coupled to a processor (1308). For example, the user interface may be a user application, browser, user interface, and/or similar words used herein interchangeably executing on and/or accessible via the user computing entity (1302) to interact with and/or cause display of information from the management computing entity (1202), as described herein. The user input interface can include any of a number of devices or interfaces allowing the user computing entity (1302) to receive data, such as a keypad (1314) (hard or soft), a touch display, voice/speech or motion interfaces, or other input device. In embodiments including a keypad (1314), the keypad (1314) can include (or cause display of) the conventional numeric (0-9) and related keys (#, *), and other keys used for operating the user computing entity (1302) and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity (1302) can also include volatile storage or memory (1318) and/or non-transitory storage or memory (1320), which can be embedded and/or may be removable. For example, the non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory can store databases, database instances, database management systems, data, applications, programs, program modules, scripts, source code, object code, byte code, compiled code, interpreted code, machine code, executable instructions, and/or the like to implement the functions of the user computing entity (1302). As indicated, this may include a user application that is resident on the entity or accessible through a browser or other user interface for communicating with the management computing entity (1202) and/or various other computing entities.

In another embodiment, the user computing entity (1302) may include one or more components or functionality that are the same or similar to those of the management computing entity (1202), as described in greater detail above. As will be recognized, these architectures and descriptions are provided for exemplary purposes only and are not limiting to the various embodiments.

### Exemplary Client Server Environment

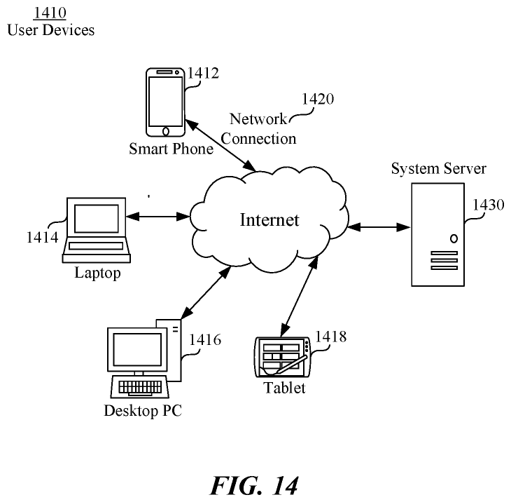

The present invention may be implemented in a client server environment. FIG. 14 shows an illustrative system architecture for implementing one embodiment of the present invention in a client server environment. User devices (i.e., image-capturing device) (1410) on the client side may include smart phones (1412), laptops (1414), desktop PCs (1416), tablets (1418), or other devices. Such user devices (1410) access the service of the system server (1430) through some network connection (1420), such as the Internet.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service) and increases user satisfaction and ease of use. Various business models, revenue models, and delivery mechanisms for the present invention are envisioned, and are all to be considered within the scope of the present invention.

### Additional Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flow described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto optical disks, or optical disks. However, a computer need not have such devices. Devices suitable for storing computer program instructions and information/data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back end component, e.g., as an information/data server, or that includes a middleware component, e.g., an application server, or that includes a front end component, e.g., a client computer having a graphical user interface or a web browser through which a user can interact with an implementation of the subject matter described herein, or any combination of one or more such back end, middleware, or front end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module or sequence of instructions referred to as “computer program(s)” or “computer code(s).” The computer programs typically include one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### CONCLUSIONS

One of ordinary skill in the art knows that the use cases, structures, schematics, and flow diagrams may be performed in other orders or combinations, but the inventive concept of the present invention remains without departing from the broader scope of the invention. Every embodiment may be unique, and methods/steps may be either shortened or lengthened, overlapped with the other activities, postponed, delayed, and continued after a time gap, such that every use case and application is accommodated to practice the methods of the present invention.

Although the present invention has been described with reference to specific exemplary embodiments, it will be evident that the various modification and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

What is claimed is:

1. A computer-implemented method for generating body part measurements from a plurality of depth images of a user, the computer-implemented method executable by a hardware processor, the method comprising:
receiving the plurality of depth images of a body part of the user from an image-capturing device;
generating a plurality of individual point clouds based on the plurality of depth images;
stitching the plurality of individual point clouds into a stitched point cloud;
determining one or more three-dimensional (3D) keypoints corresponding to the body part on the stitched point cloud using a 3D keypoint deep learning network (DLN);
determining a measurement location based on the one or more 3D keypoints;
projecting the measurement location to the stitched point cloud; and
generating the body part measurement based on the projected measurement location.

2. The method of claim 1, wherein the image-capturing device is selected from the group consisting of a Lidar, a depth sensor, a three-dimensional (3D) scanner, and a range-imaging camera.

3. The method of claim 1, wherein the image-capturing device comprises a TRUEDEPTH camera.

4. The method of claim 1, wherein the depth images comprise Red Green Blue-Depth (RGB-D) images.

5. The method of claim 1, further comprising:
selecting an individual point cloud of the plurality of individual point clouds;
detecting a ground plane with respect to the selected individual point cloud by calculating an angle of the image-capturing device with respect to the ground plane using one or more sensors of the image-capturing device; and
realigning the selected individual point cloud to the ground plane based on the calculated angle of the image-capturing device.

6. The method of claim 1, further comprising:
detecting a ground plane with respect to the stitched point cloud by calculating an angle of the image-capturing device with respect to the ground plane using one or more sensors of the image-capturing device; and
realigning the stitched point cloud to the ground plane based on the calculated angle of the image-capturing device.

7. The method of claim 1, further comprising:
receiving a two-dimensional (2D) image of the body part, wherein the 2D image is selected from the group consisting of a monochrome image and a color image; and
displaying the 2D image of the body part and the generated body-part measurement through a graphical user interface (GUI).

8. The method of claim 1, further comprising:
selecting one or more subsets of the plurality of depth images, wherein each of the plurality of individual point clouds is generated based on one of the selected one or more subsets.

9. The method of claim 8, wherein selecting one or more subsets of the plurality of depth images comprises selecting a given subset of the depth images from the plurality of depth images upon detecting at least one of a user's body position, a user's body angle, and a user's face angle in the plurality of depth images.

10. The method of claim 1, further comprising:
receiving a two-dimensional (2D) image of the body part, wherein the 2D image is selected from the group consisting of a monochrome image and a color image, wherein the 2D image is captured by the image-capturing device, and wherein the image-capturing device is configured to capture a plurality of image pairs comprising a depth image and a corresponding 2D image of the user's body part; and
selecting one or more subsets of the plurality of image pairs, wherein each of the plurality of individual point clouds is generated based on one of the selected one or more subsets of image pairs.

11. The method of claim 10, wherein selecting one or more subsets of the plurality of image pairs comprises selecting a given subset of the image pairs from the plurality of image pairs upon detecting at least one of a user's body position, a user's body angle, and a user's face angle in the plurality of image pairs.

12. The method of claim 1,
wherein projecting the measurement location to the stitched point cloud comprises determining one or more projection points of the user's body part location on the stitched point cloud, and
wherein generating the body part measurement based on the projected measurement location comprises measuring at least one of a distance, a circumference, and an angle along the one or more projection points on the stitched point cloud.

13. The method of claim 1, further comprising:
selecting a base three-dimensional (3D) model from a database;
morphing the base 3D model to match the stitched point cloud to generate a morphed 3D model; and
determining the measurement location based on the morphed 3D model.

14. The method of claim 1, wherein the 3D keypoint DLN has been trained on 3D keypoint training data comprising one or more sample point clouds and one or more corresponding 3D keypoint sets.

15. The method of claim 12,
wherein the one or more projection points are determined using a projection point deep learning module, and
wherein the projection point deep learning module is a DLN that has been trained on training data comprising one or more sample 3D point clouds and one or more corresponding sample body part projection points.

16. The method of claim 1, wherein stitching the plurality of individual point clouds comprises using a multiway registration process.

17. A non-transitory computer-readable storage medium storing program instructions for generating body part measurements from a plurality of depth images of a user, the program instructions executable by a processor to cause the processor to:
receive the plurality of depth images of a body part of the user from an image-capturing device;
generate a plurality of individual point clouds based on the plurality of depth images;
stitch the plurality of individual point clouds into a stitched point cloud;
determine one or more three-dimensional (3D) keypoints corresponding to the body part on the stitched point cloud using a 3D keypoint deep learning network (DLN);
determine a measurement location based on the one or more 3D keypoints;
project the measurement location to the stitched point cloud; and
generate the body part measurement based on the projected measurement location.

18. The non-transitory computer-readable storage medium of claim 17, wherein the program instructions for generating body part measurements from a plurality of depth images of a user comprise program instructions to:
detect a ground plane with respect to the stitched point cloud by calculating an angle of the image-capturing device with respect to the ground plane using one or more sensors of the image-capturing device; and
realign the stitched point cloud to the ground plane based on the calculated angle of the image-capturing device.

19. The non-transitory computer-readable storage medium of claim 17,
wherein the program instructions to project the measurement location to the stitched point cloud comprise program instructions to determine one or more projection points of the user's body part location on the stitched point cloud, and
wherein the program instructions to generate the body part measurement based on the projected measurement location comprise program instructions to measure at least one of a distance, a circumference, and an angle along the one or more projection points on the stitched point cloud.

20. The non-transitory computer-readable storage medium of claim 17, wherein the program instructions to stitch the plurality of individual point clouds comprise program instructions to use a multiway registration process.
